(19) United States
(12) Patent Application Publication
(10) Pub. No.: US 2005/0275625 A1
(43) Pub. Date: Dec. 15, 2005

(54) Ergonomic computer input device having pistol-type grip

(76) Inventor: Douglas Wayne Koenig, Battle Ground, WA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/869,421

(22) Filed: Jun. 15, 2004

(51) Int. Cl. G06F 17/00

(52) U.S. Cl. 345/156; 715/865

(57) ABSTRACT

A computer input device includes a housing having top, bottom, front, and back surfaces. The housing is adapted to be held in pistol-type grip with the bottom surface positioned adjacent a reference surface. First and second finger activation devices are mounted in the housing to be exposed on the front surface of the housing. A position sensor is mounted in the housing to detect through the bottom surface of the housing movement of the input device relative to the reference surface. Electronic circuitry in the housing is coupled to the position sensor and to the first and second finger activation devices. A third finger activation device may be exposed on the top surface of the input device, with the first and second finger activation devices being buttons and the third being a scroll wheel.

### BACKGROUND OF THE INVENTION

A computer mouse is a type of computer input device that allows a user to position a cursor on a display screen of the computer system and to provide user input to the computer system, typically through buttons located on the mouse. A conventional mouse typically includes a left button, a right button, and a scroll wheel which have different functions depending on the particular program executing on the computer system. Typically, for right-handed users the left button allows a user to select and manipulate objects on the display screen while the right button allows a user to access special or advanced features that are a function of the current position of the cursor. For example, when viewing a document within a word processor the right button may provide a user with access to advanced or shortcut menus relevant to text formatting such as font and paragraph menus. The scroll wheel is, as its name indicates, a wheel that may be rotated by the user to scroll up or down within a document.

A conventional mouse has a body that usually has an arced top with the left and right buttons and the scroll wheel positioned towards a front end of the mouse. The scroll wheel is positioned between the left and right buttons. When using the mouse, a user puts a base of the mouse opposite the front end in the palm of his hand and his index finger on the left button and middle finger on the right button. An optical or other type of sensor contained on a bottom of the mouse opposite the top and is positioned on a flat surface. During operation of the mouse, the user grips the mouse in his palm with fingers positioned as just described and moves the mouse in desired direction of cursor movement. The sensor detects this movement of the mouse and supplies an input signal to the computer system which, in turn, positions the cursor on the screen to track the position indicated by the input signal. The input signals also indicate use of the left and right buttons and the scroll wheel, and the computer system responds as previously described in response use of these buttons or the scroll wheel.

With the conventional mouse, the user's hand is positioned palm down on the top of the mouse during use of the mouse. This positioning of the user's hand and motion of the user's wrist and arm during operation results in the use of muscles in the wrist and arm in such a way that injury to the users arm and wrist may result from repetitive use of the mouse. The most common example of this type of repetitive motion injury is carpel tunnel syndrome. The carpel tunnel is like conduit of tissue through which nerves and other tissues are routed into a person's hand. The carpel tunnel includes the nerves and tendons associated with a person's thumb, index finger, and middle finger. Carpel tunnel syndrome is the phenomenon that results when these tendons running through the carpel tunnel become inflamed, pressing the nerves against the walls of the tunnel. This pressing of the nerves against the tunnel walls results in the familiar “carpel tunnel syndrome,” which may manifest itself in a user as numbness, pain, and tingling in the thumb and middle fingers, along with a weakening of the user's grip and overall diminished strength in the hand. The palm-down positioning of a user's hand during use of a conventional mouse causes the use of the tendons in the carpal tunnel and muscles in the user's arm in such a way that carpal tunnel syndrome occurs in some users.

There is a need for a computer input device that reduces the stress placed on tendons and muscles in a user's arm during use of the computer input device.

### SUMMARY OF THE INVENTION

According to one aspect of the present invention, a computer input device includes a housing having top, bottom, front, and back surfaces. The housing is adapted to be held in pistol-type grip with the bottom surface positioned adjacent a reference surface. First and second finger activation devices are mounted in the housing to be exposed on the front surface of the housing. A position sensor is mounted in the housing to detect through the bottom surface of the housing movement of the input device relative to the reference surface. Electronic circuitry in the housing is coupled to the position sensor and to the first and second finger activation devices and is operable to generate input signals responsive to signals from the position sensor and the first and second finger activation devices.

The input device may further include a third finger activation device exposed on the top surface of the housing and being controllable by a thumb of a user. The first and second finger activation devices may be buttons and the third activation device a scroll wheel. A rotatable base may also be coupled to the housing to allow a user to position the housing in a particular orientation relative to the base. A distance of the bottom surface of the input device from a reference surface may also be detected and functions assigned to detected distances to provide additional inputs via the input device. The functions performed by the various finger activation devices may be programmable.

### BRIEF DESCRIPTION OF THE DRAWINGS

FIG. 1A is a side view of a computer input device having a pistol-type grip according to one embodiment of the present invention.

FIG. 1B is a front view of the computer input device of FIG. 1A.

FIG. 1C is a top view of the computer input device of FIG. 1A.

FIG. 1D is a side view of the computer input device of FIG. 1A being held by a user and showing the positioning of the user's wrist and arm during use of the input device.

FIG. 2A is a side view of a computer input device having a pistol-type grip and a rotatable base according to another embodiment of the present invention.

FIG. 2B is a front view of the computer input device of FIG. 2A.

FIG. 2C is a top view of the computer input device of FIG. 1A.

FIG. 2D is a showing the scroll wheel button of FIG. 2C positioned in first and second selectable positions.

FIG. 2E is a side view of the computer input device of FIG. 2A being held by a user and showing the positioning of the user's wrist and arm during use of the input device.

FIG. 3 is a functional block diagram of a computer system including the computer input device of FIGS. 1A or 2A according to another embodiment of the present invention.

### DETAILED DESCRIPTION OF PREFERRED EMBODIMENTS

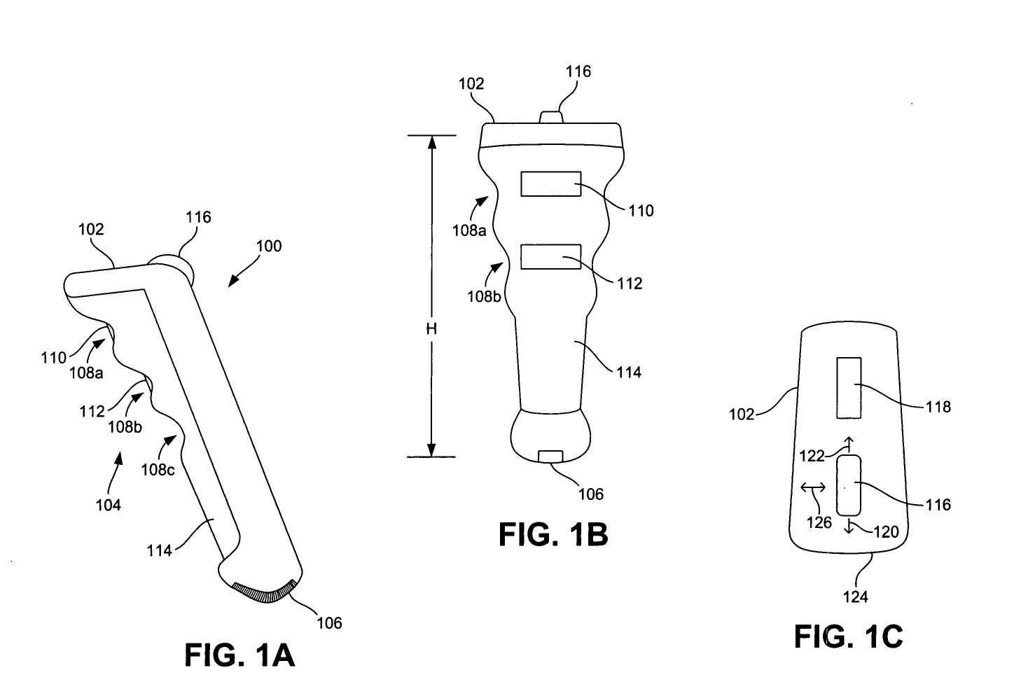

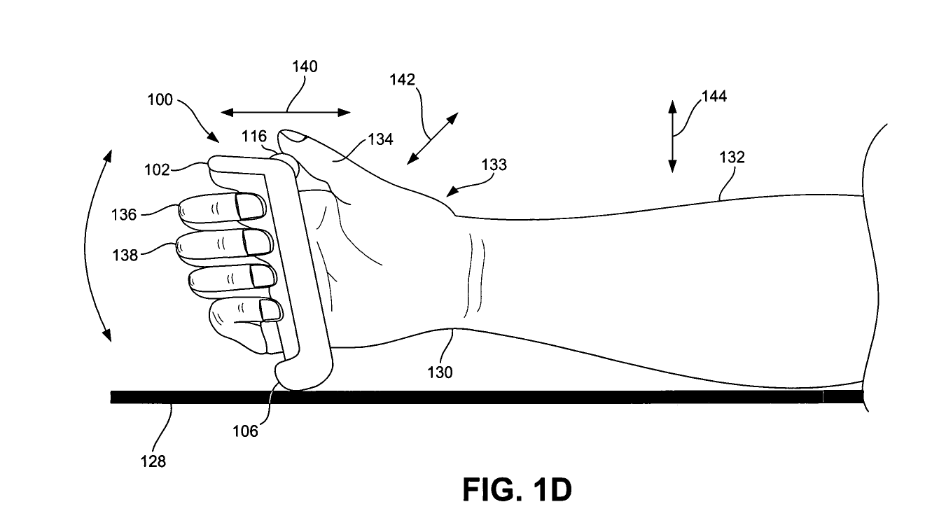

FIG. 1A is a side view of a computer input device 100 including a housing 102 having a pistol-type grip 104 according to one embodiment of the present invention. In operation, the computer input device 100 enables the user to hold and operate the device in a more natural and comfortable position that places less strain on muscles and tendons in the user's arm and hand. As a result, repetitive stress injuries such as carpal tunnel syndrome will be reduced relative to conventional computer mice since the computer input device 100 does not require the user to operate the device in the conventional palm-down the position but instead in a more natural pistol-type grip position, as will be explained in more detail below.

In the following description, certain details are set forth in conjunction with the described embodiments of the present invention to provide a sufficient understanding of the invention. One skilled in the art will appreciate, however, that the invention may be practiced without these particular details. Furthermore, one skilled in the art will appreciate that the example embodiments described below do not limit the scope of the present invention, and will also understand that various modifications, equivalents, and combinations of the disclosed embodiments and components of such embodiments are within the scope of the present invention. Embodiments including fewer than all the components of any of the respective described embodiments may also be within the scope of the present invention although not expressly described in detail below. Moreover, in the description that follows, it is understood that the figures related to the various embodiments are not to be interpreted as conveying any specific or relative physical dimensions, and that specific or relative physical dimensions, if stated, are not to be considered limiting unless the claims expressly state otherwise. Finally, the operation of well known components and/or processes has not been shown or described in detail below to avoid unnecessarily obscuring the present invention.

The computer input device 100 includes an optical sensor 106 positioned at a bottom surface of the housing 102. The optical sensor 106 detects movement of the computer input device 100 relative to a reference surface (not shown) on which the bottom surface of the housing 102 and thus the optical sensor are placed. In the embodiment of FIG. 1A, the bottom surface of the housing 102 is arced to allow a user hold the computer input device 100 at a comfortable angle during operation, as will be explained in more detail below. The pistol-type grip 104 is formed on a front surface of the housing 102 and includes three finger grooves 108a-c, each finger groove receiving a respective finger of the user during operation. More specifically, the finger groove 108a receives the user's index finger, the groove 108b receives the user's middle finger, while the groove 108c receives the user's ring finger.

A first button 110 is mounted in the housing 102 to be exposed within the finger groove 108a and a second button 112 is mounted in the housing 102 to be exposed within the finger groove 108b, with the second finger activation device also being a button in this embodiment. The buttons 110 and 112 may be programmed to perform desired functions, and in one embodiment the buttons 110 and 112 correspond to the left and right buttons, respectively, on a conventional mouse. The computer input device 100 may also include a comfort grip material 114 formed on the front surface of the housing 102. For example, a rubber type comfort material that provides a slightly elastic and non-slip surface may be utilized, such as commonly found on pens and other devices. Finally, the computer input device 100 includes a scroll wheel 116 mounted in the housing 102 to be exposed on a top surface of the housing and being controllable by the thumb of the user. The computer input device 100 further includes electronic circuitry (not shown) coupled to the optical sensor 106, the buttons 110 and 112, and the scroll wheel 116 and receives signals from each of these components. The electronic circuitry communicates these signals to a computer system (not shown) to which the input device 100 is coupled, either through a wired or a wireless connection.

FIG. 1B is a front view of the computer input device 100 of FIG. 1A showing the buttons 110 and 112 positioned within the finger grooves 108a and 108b, respectively, and also showing the position of the scroll wheel 116 in a center of the top surface of the housing 102. The housing 102 has a height H that allows the user to comfortably hold the computer input device 100 during operation. Different sizes of the computer input device 100, each having a different height H and possibly other different physical dimensions, may also be formed to provide users with the option of selecting the size that is most comfortable for the user.

FIG. 1C is a top view of the computer input device 100 of FIG. 1A showing the position of the scroll wheel 116 and also showing the location of a battery cover 118 that may be formed on a back surface of the housing 102, with batteries being place a suitable compartment (not shown) under the cover to power the electronic circuitry. The scroll wheel 116 is oriented to be operated in a frontward and backward direction as illustrated by arrows 120 and 122. In this embodiment, the frontward and backward directions 120, 122 are substantially perpendicular to a front surface 124 of the housing 102. In another embodiment, the scroll wheel 116 may be rotated 90 degrees from the position shown and thus be oriented to be operated in a leftward and a rightward direction substantially parallel to the front surface 124 as illustrated by an arrow 126. Alternatively, the scroll wheel 116 may be adjustable to any position between the position shown and the rotated 90 degree position, allowing the user to select the desired position.

The operation of the computer input device 100 will now be described with reference to FIG. 1D, which is a side view of the computer input device being held by a user. The figure shows the input device 100 being held with the optical sensor 106 placed on a reference surface 128, and also shows the positioning of a wrist 130 and arm 132 of the user during operation of the input device. The user holds the computer input device 100 in his hand 133 in a pistol-type grip with a thumb 134 of the user being positioned on the scroll wheel 116 and an index finger 136 and middle finger 138 of the user positioned to control the buttons 110 and 112 (not shown), respectively. In operation, the user maintains the optical sensor 106 pressed against the reference surface 128 and moves the computer input device 100 in a forward and backward direction as indicated by an arrow 140 to move the cursor (not shown) up and down on the computer display screen (not shown). To move the cursor left and right, the user simply moves the input device 100 leftward and rightward as indicated by an arrow 142. Electronic circuitry (not shown) in the computer input device 100 detects signals generated by the optical sensor 106 in response to these movements and communicates these signals to an associated computer system (not shown), and the same is true of signals from the buttons 110 and 112 and the scroll wheel 116 in response to user actions. In another embodiment, the electronic circuitry also receives signals from the optical sensor 106 indicating a vertical distance of the bottom arced surface of the housing 102 from the reference surface 128 as indicated by an arrow 144. In the computer system coupled to the computer input device 100, various values of this detected vertical distance may then be assigned respective functions.

FIG. 1D illustrates that with the computer input device 100 the user holds and operates the device in a more natural and comfortable position that places less strain on muscles and tendons in the user's arm 132 and hand 133. The user's wrist 130 is not oriented downward toward the reference surface 128 as with a conventional mouse, but is instead a rotated approximately 90 degrees with the users from 134 facing upward. This positioning should reduce repetitive stress injuries such as carpal tunnel syndrome relative to conventional computer mice. Also note that with the computer input device 100, the device may be designed for both right-handed and left-handed users without any reprogramming of the buttons 110 and 112 being required. This is true because a user's index finger controls the button 110 and middle finger controls the button 112 regardless of whether the user holds the device 100 with his left or right hand. This is contrary to conventional mice where the left and right buttons must be reprogrammed for right-handed and left-handed users to provide the same button orientation for both types of users. In other embodiments, the shape of the housing 102 may be customized for use by either a left- or right-handed user, with two models of the input device 100 being manufactured in this situation.

In the embodiment of FIGS. 1A-1D, the buttons 110, 112 and the scroll wheel 116 may be generically referred to as finger activation devices, and in other embodiments may be different types of activation devices. Moreover, in other embodiments of the computer input device 100 the pistol-type grip 104 may include additional finger grooves and each finger groove may also include a corresponding finger activation device. Although the sensor 106 is described as being an optical sensor, other types of sensors could also be utilized such as a roller-type ball sensor that is still utilized in many conventional mice. Also, although the bottom surface of the housing 102 is described as being arced, the surface could alternatively be flat in other embodiments of the present invention. Communications between the computer input device 100 and an associated computer system may be through any suitable communications links, such as wires or various wireless communications links such as a radio frequency (RF) or infrared (IR) links. Those skilled in the art will also understand suitable materials for forming the components of the various embodiments and will also understand suitable electronic circuitry for the performing the functions required by the described embodiments of computer input devices.

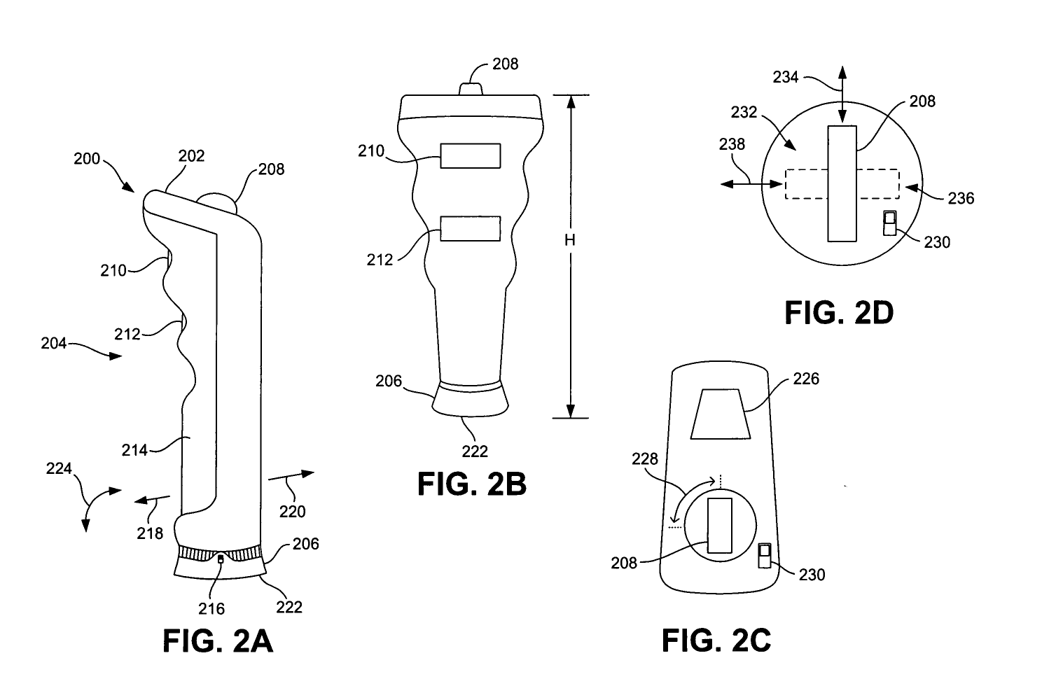

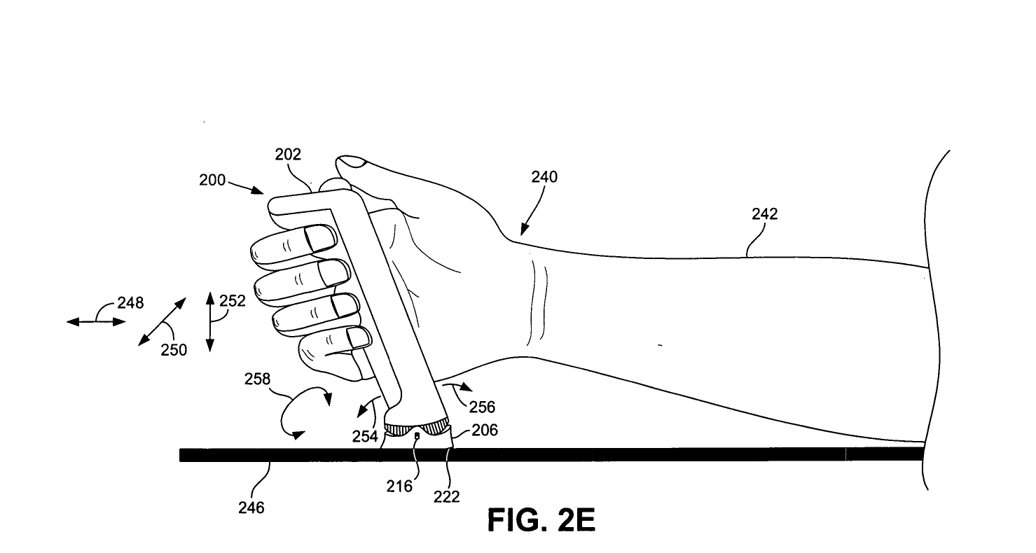

FIG. 2A is a side view of a computer input device 200 including a housing 202 having a pistol-type grip 204 and a rotatable base 206 according to another embodiment of the present invention. The computer input device 200 includes a scroll wheel 208, the first and second buttons 210, 212, comfort grip material 214, an optical sensor (not shown), and electronic circuitry (not shown) that operate in the same way as previously described for the corresponding components with reference to the computer input device 100 of FIGS. 1A-D. Thus, for the sake of brevity, these components will not again be described in detail for the computer input device 200.

In the computer input device 200, rotatable base 206 enables the user to select a desired orientation of the housing 202 relative to the base to provide for more comfortable use of the input device. More specifically, the rotatable base 206 includes a locking mechanism 216 that allows the user to select the desired orientation and then to lock this position of the housing 202 relative to the base. In one embodiment, when the locking mechanism 216 is released the user may move the housing 202 in a forward and a backward direction relative to the base 206 as illustrated by arrows 218, 220. The user may further rotate the housing 202 in a clockwise or counterclockwise direction in a plane parallel to a bottom surface 222 of the base, as illustrated by an arrow 224. Once again, note that the bottom surface 222 of the base 206 may be arced or may be flat, and also note that the material of the base must allow the optical sensor to sense movement of the computer input device 200 relative to a reference surface (not shown) on which the bottom surface is resting.

FIG. 2B is a front view of the computer input device 200 of FIG. 2A illustrating the positioning of the scroll wheel 208, buttons 210 and 212, and arced shape of the bottom surface 222 of the base 206. FIGS. 2C and 2D are top views of the computer input device 200 of FIG. 1 showing a battery cover 226 on a back surface of the housing 202 and illustrating in more detail a rotatable embodiment of the scroll wheel 208 according to one embodiment of the present invention. As illustrated by an arrow 228, the scroll wheel 208 is rotatable by approximately 90 degrees to be positioned as desired by the user. A locking mechanism 230 one released allows the user to position the scroll wheel 208 in the desired position, and when engaged the locking mechanism locks the scroll wheel in the selected position. FIG. 2D shows the scroll wheel 208 locked in a first position 232 in which the scroll wheel is movable in a front word and backward direction as indicated by an arrow 234. The scroll wheel 208 is shown locked in a second position 236 as indicated by dotted lines, and in this position is movable in a sideways direction as indicated by an aero 238. As previously mentioned, in one embodiment the user may select any position between the positions 232 and 236 and a lock the scroll wheel 208 in the desired position.

FIG. 2E is a side view of the computer input device 200 of FIGS. 2A being held by a user and showing the positioning of the user's wrist 230 and arm 242 during operation of the input device. In operation, the user holds the computer input device 200 as shown and presses the bottom surface 222 of the base 206 against a reference surface 226 and thereafter moves the input device in a forward and backward direction indicated by an arrow 248, in a sideways direction indicated by an arrow 250, and possibly in a vertical direction as indicated by an arrow 252. The computer input device 200 operates in the same manner as previously described for the computer input device 100 with reference to FIG. 1D, and thus, for the sake of brevity, this operation will not again be described in detail. Note that with the computer input device 200, however, the orientation of the housing 202 relative to the base 206 is selectable by the user through the locking mechanism 216. As shown in FIG. 2E, the user may rotate the housing 202 in a forward and backward direction as indicated by arrows 254 and 256, and they also rotate the housing 202 relative to the base 206 clockwise or counterclockwise as indicated by an arrow 258 in a plane parallel to the reference surface 246. The base 206 thereby allows the user to customize the feel of the computer input device 200 to provide for more comfortable and efficient utilization of the input device.

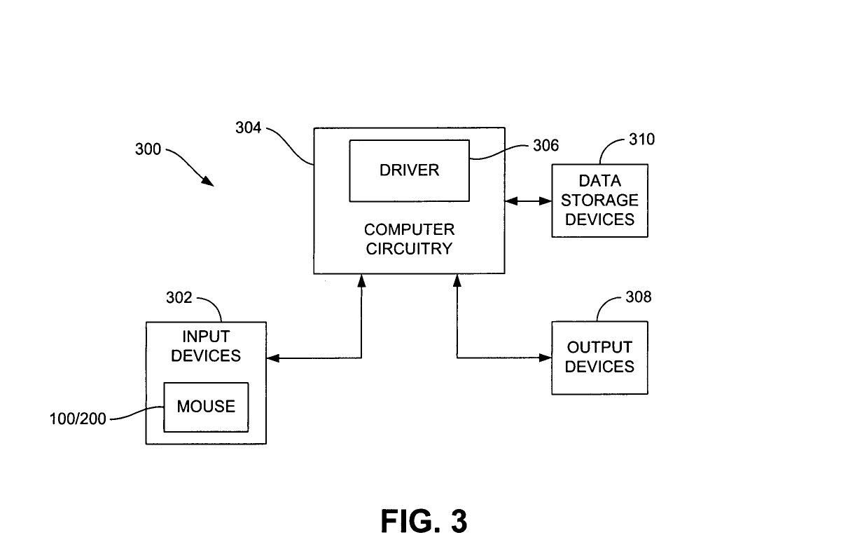

FIG. 3 is a functional block diagram of a computer system 300 including a plurality of input devices 302 including the computer input device 100 or 200 of FIGS. 1A-1D or 2A-2E according to another embodiment of the present invention. The computer system 300 includes computer circuitry 304 for performing various computing functions, such as executing specific software to perform specific calculations or tasks. The computer circuitry 304 executes a driver component 306 that communicates with the computer input device 1001200 to provide input from the input device to the computer circuitry. The driver component 306 allows a user to program the functions performed by any of the finger activation devices on the computer input devices 100/200, such as the buttons 110,112 on the device 100. In the computer system 300, the input devices 302 includes other input devices such as a keyboard that are also coupled to the computer circuitry 304 to allow an operator to interface with the computer system. Typically, the computer system 300 also includes one or more output devices 308 coupled to the computer circuitry 304, such output devices typically including a printer and a video terminal. One or more data storage devices 310 are also typically coupled to the computer circuitry 304 to store data or retrieve data from external storage media (not shown). Examples of typical storage devices 310 include hard and floppy disks, tape cassettes, compact disk read-only (CD-ROMs) and compact disk read-write (CD-RW) memories, and digital video disks (DVDs).

Even though various embodiments and advantages of the present invention have been set forth in the foregoing description, the above disclosure is illustrative only, and changes may be made in detail and yet remain within the broad principles of the present invention. Therefore, the present invention is to be limited only by the appended claims.

1. A computer input device, comprising:
a housing including a top surface, a bottom surface, a front surface, and a back surface, the housing being adapted to be held in pistol-type grip with the bottom surface positioned adjacent a reference surface;
a first finger activation device mounted in the housing to be exposed on the front surface of the housing and operable to generate a first signal responsive to being activated;
a second finger activation device mounted in the housing to be exposed on the front surface of the housing adjacent the second finger activation operable to generate a second signal responsive to being activated;
a position sensor mounted in the housing and operable to detect through the bottom surface of the housing movement of the input device relative to the reference surface and to generate a signal indicating the detected movement; and
electronic circuitry mounted in the housing and coupled to the position sensor and to the first and second finger activation devices, the electronic circuitry operable to generate input signals responsive to signals from the position sensor and the first and second finger activation devices.

2. The computer input device of claim 1 wherein the bottom surface comprises an arced surface.

3. The computer input device of claim 1 further comprising a base rotatably attached to the housing near the bottom surface of the housing, the base including a detection surface adapted to be positioned adjacent the reference surface and the bottom surface of the housing being positioned adjacent the detection surface, the housing being operable to rotate in at least one direction relative to the base.

4. The computer input device of claim 3 wherein the base is operable to allow the housing to rotate in a forward and backward direction relative to the base and in a sideways direction relative to the base.

5. The computer input device of claim 1 wherein the front surface includes at least a first finger groove adapted to receive an index finger and a second finger groove adapted to receive a middle finger, with the first and second finger activation devices being positioned in the first and second finger grooves, respectively.

6. The computer input device of claim 1 wherein the first and second finger activation devices comprise buttons.

7. The computer input device of claim 1 further comprising a third finger activation device mounted in the housing to be exposed on the top surface of the housing, the third finger activation device being adapted to be controlled by a thumb of a user.

8. The computer input device of claim 7 wherein the third finger activation device comprises a scroll wheel.

9. The computer input device of claim 8 wherein the scroll wheel is adjustable between a first position in which the wheel is rotatable in a direction substantially perpendicular to the front surface of the housing and a second position in which the wheel is rotatable in a direction substantially parallel to the front surface of the housing.

10. The computer input device of claim 1 wherein the housing is formed from a single integrated piece of material that is adapted for use by left- and right-handed users without the need to reprogram the first and second finger activation devices.

11. The computer input device of claim 1 wherein the position sensor is further operable detect a distance of the bottom surface of the computer input device from the reference surface.

12. A computer input device, comprising:
a housing including a top surface, a bottom surface, a front surface, and a back surface, and including on the front surface at least a first finger groove adapted to receive an index finger of a user and a second finger groove adjacent the first finger groove and adapted to receive a middle finger of the user;
a first finger activation device mounted to the housing and exposed in the first finger groove on the front surface of the housing, the first finger activation device adapted to be activated by the index finger of the user;
a second finger activation device mounted to the housing and exposed in the second finger groove on the front surface of the housing, the second finger activation device adapted to be activated by the middle finger of the user;
a third finger activation device mounted to the housing and exposed on the top surface of the housing, the third finger activation device being adapted to be activated by a thumb of the user;
a position sensor mounted in the housing and operable to detect through the bottom surface of the housing movement of the input device relative to the reference surface; and
electronic circuitry mounted in the housing and coupled to the position sensor and to the first, second, and third finger activation devices.

13. The computer input device of claim 12 wherein the first and second finger activation devices comprise buttons and wherein the third finger activation device comprises a scroll wheel.

14. The computer input device of claim 13 wherein the scroll wheel is adjustable between a first position in which the wheel is rotatable in a direction substantially perpendicular to the front surface of the housing and a second position in which the wheel is rotatable in a direction substantially parallel to the front surface of the housing.

15. The computer input device of claim 14 wherein the bottom surface comprises an arced surface.

16. The computer input device of claim 12 further comprising a base rotatably attached to the housing near the bottom surface of the housing, the base including a detection surface adapted to be positioned adjacent the reference surface and the bottom surface of the housing being positioned adjacent the detection surface, the housing being operable to rotate in at least one direction relative to the base.

17. The computer input device of claim 16 wherein the base is operable to allow the housing to rotate in a forward and backward direction relative to the base and in a sideways direction relative to the base.

18. The computer input device of claim 12 wherein the position sensor is further operable detect a distance of the bottom surface of the computer input device from the reference surface.

19. The computer input device of claim 12 further comprising third and fourth grooves on the front surface of the housing, and wherein fourth and fifth finger activation devices are mounted to the housing and exposed in the third and fourth grooves, respectively.

20. A computer input device, comprising:
a housing including a top surface, a bottom surface, a front surface, and a back surface, and including on the front surface at least a first and second finger grooves;
a first finger activation device mounted to the housing and exposed in the first finger groove;
a second finger activation device mounted to the housing and exposed in the second finger groove;
a third finger activation device mounted to the housing and exposed on the top surface of the housing;
a position sensor mounted in the housing; and
electronic circuitry mounted in the housing and coupled to the position sensor and to the first, second, and third finger activation devices.

21. The computer input device of claim 20 wherein the first and second figure activation devices comprise buttons and wherein the third activation device comprises a scroll wheel.

22. The computer input device of claim 20 further comprising a rotatable base mounted to the housing near the bottom surface.

23. The computer input device of claim 22 wherein the rotatable base includes a substantially flat surface.

24. A computer system, comprising:
computer circuitry;
a data output device;
a data storage device; and
data input devices coupled to the computer circuitry, the data input devices including a computer input device including,
a housing including a top surface, a bottom surface, a front surface, and a back surface, the housing being adapted to be held in pistol-type grip with the bottom surface positioned adjacent a reference surface;
a first finger activation device mounted in the housing to be exposed on the front surface of the housing and operable to generate a first signal responsive to being activated;
a second finger activation device mounted in the housing to be exposed on the front surface of the housing adjacent the second finger activation operable to generate a second signal responsive to being activated;
a position sensor mounted in the housing and operable to detect through the bottom surface of the housing movement of the input device relative to the reference surface and to generate a signal indicating the detected movement; and
electronic circuitry mounted in the housing and coupled to the position sensor and to the first and second finger activation devices, the electronic circuitry operable to generate input signals responsive to signals from the position sensor and the first and second finger activation devices, and operable to apply the input signals to the computer circuitry.

25. The computer system of claim 24 wherein the computer circuitry executes a program that processes signals from the electronic circuitry in the computer input device, and wherein the program is operable to assign functions associated with each of finger activation devices of the computer input device.

26. The computer system of claim 24 wherein the position sensor is further operable generate a vertical distance signal indicating a distance between the bottom surface of the computer input device and the reference surface, and wherein the computer circuitry executes a program that processes the vertical distance signal to determine a value of the distance signal and which assigns functions to various values of the vertical distance signal.

27. A method providing user input to a computer system using a computer input device, the method comprising:
detecting a distance of the computer input device from a reference surface; and
providing the detected value of the distance to the computer system.

28. The method of claim 27 further comprising:
assigning functions to various detected distance values; and
executing the assigned functions in the computer system responsive to the corresponding distance value being detected.

29. The method of claim 27 further comprising:
grasping the input device in a pistol-grip type manner with an outer edge of a user's hand being positioned adjacent a reference surface; and
providing input to the computer system using at least one of an index finger and middle finger.
